(19) United States
(12) Patent Application Publication
(10) Pub. No.: US 2017/0091053 A1
(43) Pub. Date: Mar. 30, 2017

(54) METHOD AND DEVICE FOR CHECKING CALCULATION RESULTS IN A SYSTEM HAVING MULTIPLE PROCESSING UNITS

(71) Applicant: Robert Bosch GmbH, Stuttgart (DE)

(72) Inventors: Mikkel Liisberg, Stuttgart (DE); Roland Schleser, Abstatt (DE)

(21) Appl. No.: 15/276,117

(22) Filed: Sep. 26, 2016

(30) Foreign Application Priority Data
Sep. 30, 2015 (DE) 102015218882.5

(51) Int. Cl. G06F 11/20

(52) U.S. Cl. CPC G06F 11/202

(57) ABSTRACT

A method for checking calculation results in a system including multiple processing units including receiving a data frame from one of the processing units, the data frame includes an application identification and a number of comparison values of the processing unit, the comparison values of the processing unit are sorted into a buffer memory on the basis of the application identification, it is checked whether the buffer memory under the application identification contains the comparison values of all processing units, and if the comparison values are completely present, the comparison values are compared.

### CROSS REFERENCE

The present application claims the benefit under 35 U.S.C. §119 of German Patent Application No. DE 102015218882.5 filed on Sep. 30, 2015, which is expressly incorporated herein by reference in its entirety.

### FIELD

The present invention relates to a method for checking calculation results in a system having multiple processing units. The present invention additionally relates to a corresponding device, a corresponding computer program, and a corresponding storage medium.

### BACKGROUND INFORMATION

Lockstep systems are error-tolerant computer systems which carry out the same set of operations in parallel at the same time or with a minimal time offset. A lockstep system according to the related art enables error detection and error correction: The output of lockstep operations may be compared to determine whether an error occurred if at least two processing units participate, and the error may be automatically corrected if at least three processing units participate. These are called double or triple modular redundancy.

German Patent Application No. DE 10 2005 037 246 A1 describes a method for controlling a computer system having at least two execution units and a comparison unit, which is operated in lockstep and in which the results of the at least two execution units are compared, wherein upon or after recognition of an error by the comparison unit on at least one execution unit, an error recognition mechanism for this execution unit is triggered.

### SUMMARY

The present invention provides a method for checking calculation results in a system having multiple processing units, a corresponding device, a corresponding computer program, and a corresponding storage medium.

In accordance with the present invention, it is not possible in safety-relevant systems, in which standard ethernet components, processing units—this means multicore systems and many-core systems, microcontrollers (μC), and microprocessors (μP)μand standard operating systems such as QNX or Linux are used, to secure the entire system by self-tests. Many safety-relevant applications, for example, in the field of automated driving, are therefore calculated redundantly (in lockstep). In standard components (without hardware assistance), the lockstep is implemented as a so-called software lockstep. In systems which place high demands on safety, availability, and performance, the safety-relevant functions are calculated in a distributed manner.

The present invention described here enables software components running in such a distributed system—made up of multiple processing units and connected by a communication bus such as CAN or Ethernet—to be distributed to multiple processing units and the calculation results to be compared by a so-called comparator at a central point in the system.

The comparator checks the calculation results of the processing units and may put the system into the safe state in case of error.

One advantage of this approach is that, in addition to the higher level of independence, a very high level of scalability is provided by an external comparator unit to a software lockstep system made up of multiple processors.

Furthermore, the comparator is configured in such a way that no pieces of information about the contents are necessary to carry out the comparison. This has the advantage that the processing unit on which the comparator is executed remains unchanged when the software changes on the other processing units.

Advantageous refinements of and improvements are made possible by way of the measures described herein. It may thus be provided that the data frame received from the comparator includes a type specification and it is checked prior to the comparison on the basis of the type specification whether the comparison values included in the data frame represent hash values or a content. The quantity of data to be compared may be reduced in this way.

According to another aspect, it may be provided that an error counter is associated with the application identification. If the comparison values deviate, the error counter is incremented; if the comparison values coincide, the error counter is decremented; and if the error counter reaches a configurable threshold, a configurable error reaction is triggered. Within the scope of a cyclic self-test, an error counter associated with a dummy application identification may be incremented by deviating comparison register contents and decremented by corresponding comparison register contents. This test checks that the comparator and error logic functions. The result of the self-test may additionally be entered as a partial response into the external communication of the runtime monitoring unit (watchdog).

### BRIEF DESCRIPTION OF THE DRAWINGS

Exemplary embodiments of the present invention are shown in the figures and are explained in greater detail below.

FIG. 1 shows a software sequence according to the invention in the comparator.

FIG. 2 shows the data sorting of the comparator.

FIG. 3 shows a typical data frame.

FIG. 4 shows a system architecture including triple modular redundancy.

FIG. 5 shows a self-test of the comparator.

FIG. 6 schematically shows a control unit according to one specific embodiment of the present invention.

### DETAILED DESCRIPTION OF EXAMPLE EMBODIMENTS

A system according to one specific embodiment includes two or more processing units, of which at least one processing unit carries out safety-relevant functions, which communicate via a standard ethernet communication bus. According to one alternative, other bus systems are used, which enable the transmission of a data packet.

One or multiple processing units run in so-called software lockstep and carry out the redundant calculation of the safety-relevant functions. One processing unit having at least two separate cores may also carry out the redundant calculation of the safety-relevant functions in software lockstep. One processing unit forms the so-called comparator, which checks results of the redundant calculation, for the software lockstep.

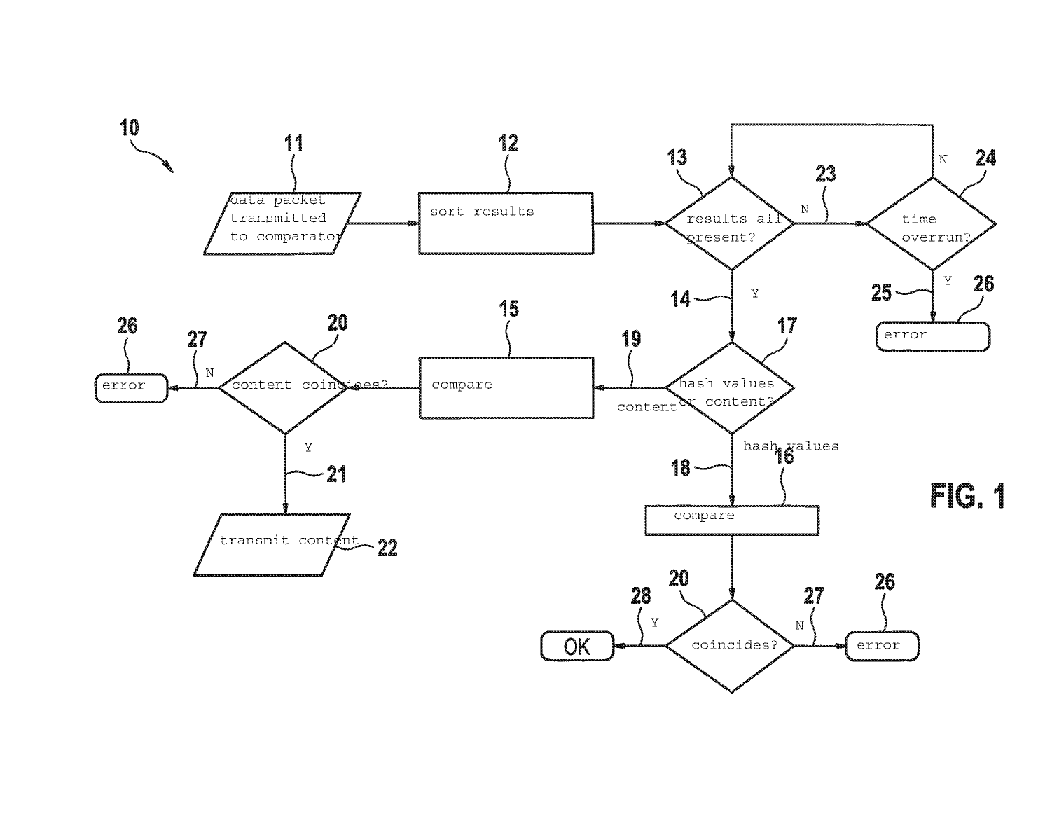

FIG. 1 illustrates the sequence of such a check: the results of a safety-relevant function or a sequence of functions are summarized after the execution in a data packet and transmitted to the comparator 11.

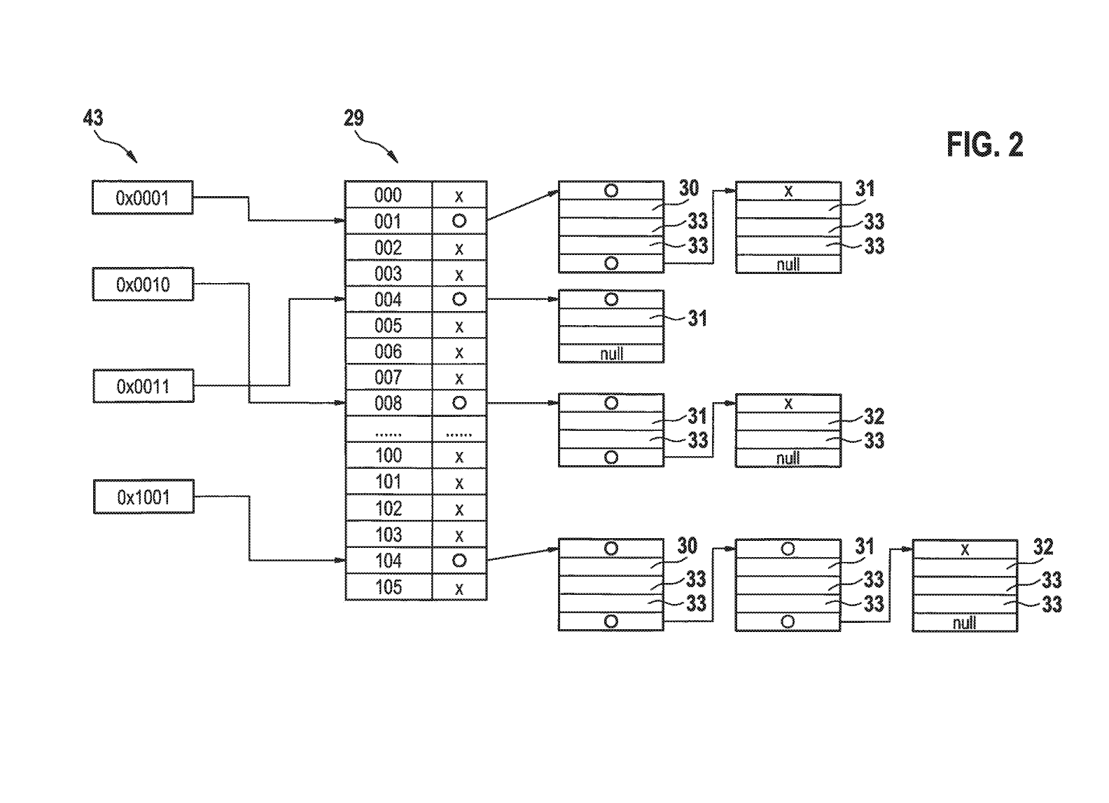

The comparator sorts 12, as shown in detail in FIG. 2, the incoming results, for example, according to the transmitting processing unit 30, 31, 32 or a unique application identification 43 (ID). If the results from all processing units are present 14, they are compared 15, 16. The comparator differentiates on the basis of a type specification 38 in the data frame between results 16 which are only to be compared, and results 15 which are to be transmitted 22 to a vehicle bus after the comparison 15. In the case of results which are to be sent 22, the contents and some of the values described hereafter are compared 15 for end-to-end (E2E) security of the data frame 42.

The results of a safety-relevant function may include, for example, output data, internal functional states, memories occupied by the function, data which are to be sent to another control unit or an actuator, or values for continuously securing the data frame, such as a so-called alive counter or a checksum. To reduce the quantity of data to be compared 16, a hash value is formed via the overall results. If the result is a data packet 15, which is to be sent 22, the content is sent that is true to the original in the data frame 22.

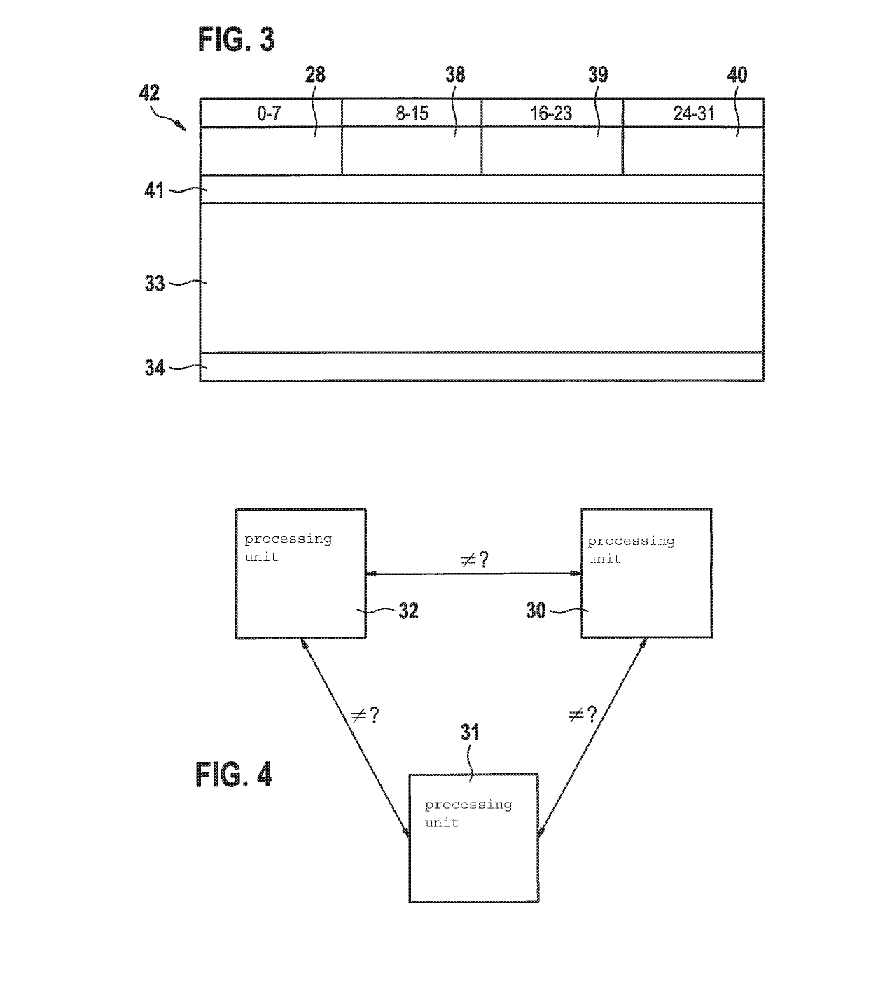

In standard data frame 42 shown in FIG. 3, one or multiple comparison values 33 are transmitted to the comparator. Data frame 42 additionally also contains application identification 43, type specification 38, number 39 of included comparison values 33, a timestamp 41, an alive counter 40, and a checksum 34 for securing data frame 42, which may be based, for example, on a cyclic redundancy check (CRC) or a cryptographic hash function.

An error counter is associated with each application identification 43 for error handling. In the event of an error, particular counter 40 is incremented and it is decremented in the event of a correct comparison. If an error counter reaches a configured threshold, an error reaction is triggered, for example, in that the system is put into a safe state. The error reaction may be configured as a function of application identification 43.

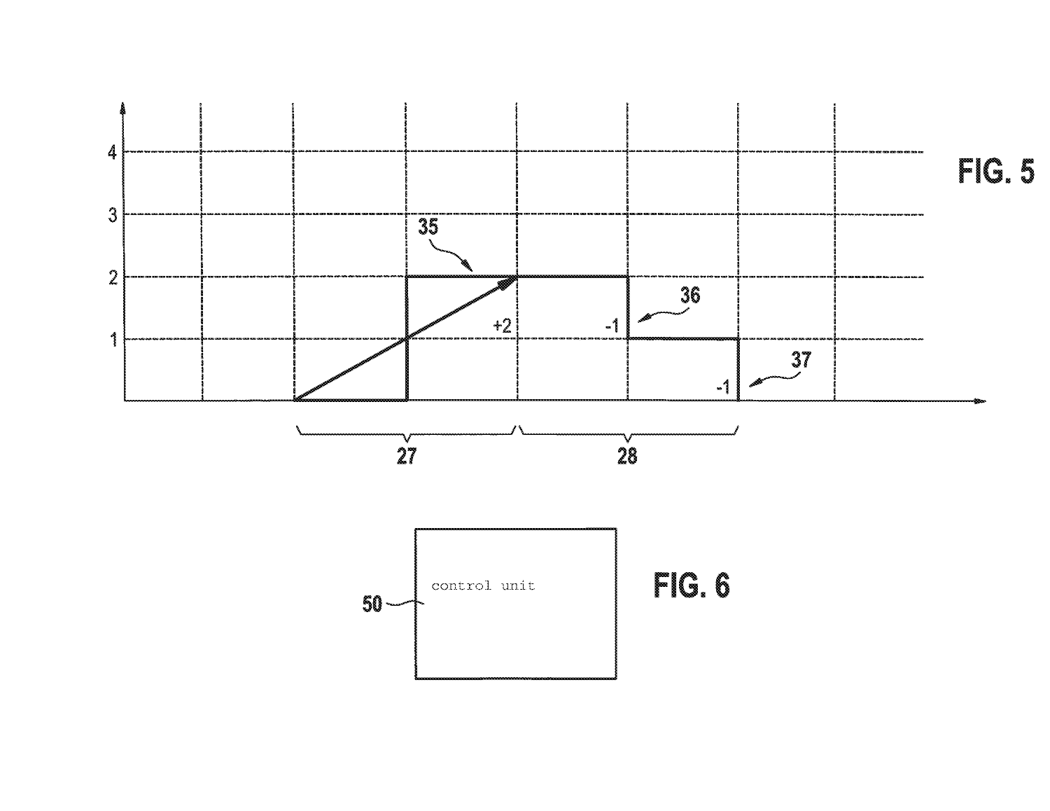

In a system including three or more processing units 30, 31, 32, the comparator may also carry out a 2-of-3 comparison, to therefore achieve a higher level of availability of the system (FIG. 4). The comparator is additionally cyclically checked by a self-test, as illustrated in FIG. 5. The test checks that the comparator and error logic functions. The self-test uses a dummy application identification 43.

This method 10 may be implemented, for example, in software or hardware or in a mixed form of software and hardware, for example, in a control unit 50, as illustrated in the schematic illustration of FIG. 6.

What is claimed is:

1. A method for checking calculation results in a system having multiple processing units, the method comprising:
receiving a data frame from one of the processing units, the data frame including an application identification and a number of comparison values of the processing unit;
sorting the comparison values of the processing unit into a buffer memory on the basis of the application identification;
checking whether the buffer memory under the application identification contains the comparison values of all processing units; and
when the comparison values are completely present, comparing the comparison values.

2. The method as recited in claim 1, wherein the data frame further includes a type specification, and the method further comprises:
prior to the comparison, checking based on the type specification whether the comparison values represent hash values or a content;
when the comparison values represent the content, checking after the comparison whether the content of all processing units coincides; and
when the content coincides, transmitting the content.

3. The method as recited in claim 2, wherein the data frame further includes an alive counter and a checksum of the comparison values, and the method further comprises:
comparing the alive counter and the checksum to the content.

4. The method as recited in claim 1, further comprising:
when the comparison values are present only incompletely, checking a time overrun; and
when the time overrun occurs, detecting an error.

5. The method as recited in claim 1, further comprising:
when the comparison values of the processing unit deviate from coinciding comparison values of a second processing unit and a third processing unit among the processing units, the comparison values of the processing unit are discarded.

6. The method as recited in claim 1, wherein an error counter is associated with the application identification, and the method further comprises:
when the comparison values deviate, incrementing the error counter;
when the comparison values coincide, decrementing the error counter; and
when the error counter reaches a configurable threshold, triggering a configurable error reaction.

7. The method as recited in claim 6, wherein in the case of a cyclic self-test, the error counter associated with a dummy application identification is incremented by deviating comparison register contents and decremented by coinciding comparison register contents.

8. A non-transitory machine-readable storage medium on which is stored a computer program for checking calculation results in a system having multiple processing units, the computer program, when executed by a processor, causing the processor to perform:
receiving a data frame from one of the processing units, the data frame including an application identification and a number of comparison values of the processing unit;
sorting the comparison values of the processing unit into a buffer memory on the basis of the application identification;
checking whether the buffer memory under the application identification contains the comparison values of all processing units; and
when the comparison values are completely present, comparing the comparison values.

9. A device for checking calculation results in a system having multiple processing units, the device designed to:
receive a data frame from one of the processing units, the data frame including an application identification and a number of comparison values of the processing unit;
sort the comparison values of the processing unit into a buffer memory on the basis of the application identification;
check whether the buffer memory under the application identification contains the comparison values of all processing units; and
when the comparison values are completely present, compare the comparison values.
